(19) United States
(12) Patent Application Publication
(10) Pub. No.: US 2009/0000419 A1
(43) Pub. Date: Jan. 1, 2009

(54) HANDLEBAR ASSEMBLY WITH AXIAL LOCKING FEATURE

(75) Inventors: Steven E. Wind, Crestwood, IL (US); James A. Wollmer, Menomonee Falls, WI (US); John Erwin Stelling, Port Washington, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/771,707

(22) Filed: Jun. 29, 2007

(51) Int. Cl. B62K 21/12

(52) U.S. Cl. 74/551.1

(57) ABSTRACT

A handlebar assembly for a motorcycle includes a riser and a cap coupled to the riser. The cap and riser define a clamp having a cavity. The handlebar assembly also includes a handlebar having a first end portion and a second end portion opposite the first end portion. The second end portion is configured to support a hand grip. The first end portion defines an axis and is at least partially received within the cavity. At least one of the clamp and the first end portion includes an axial locking feature to inhibit movement of the handlebar relative to the clamp in a direction along the axis. The axial locking feature permits rotation of the handlebar assembly about the axis to adjust the position of the second end portion.

### FIELD OF THE INVENTION

The present invention relates to a handlebar assembly for a motorcycle.

### BACKGROUND

At times, it may become desirable by a motorcyclist to vary his or her riding position. For example, city driving varies from highway or rural driving where in the former situation an upright position is desirable and in the latter situation the rider tends to lean back somewhat, away from the handlebars.

In order to accommodate the various positions used by a motorcyclist, various types of handlebars may be used. However, this requires the cyclist to possess more than one type of handlebars. Also, the extra handlebars would have to be stored on the motorcycle in the case of long distance travel. This would take additional storage space. Furthermore, owning more than one type of handlebar requires the cyclist to remove and re-install the handlebars in order to adjust the handlebar configuration. This can become a time-consuming and burdensome task.

### SUMMARY

In one embodiment, the invention provides a handlebar assembly for a motorcycle including a riser, a cap coupled to the riser, the cap and riser defining a clamp having a cavity and a handlebar having a first end portion and a second end portion opposite the first end portion. The second end portion is configured to support a hand grip. The first end portion defines an axis and is at least partially received within the cavity. At least one of the clamp and the first end portion includes an axial locking feature inhibiting movement of the handlebar relative to the clamp in a direction along the axis.

In another embodiment, the invention provides a handlebar for a motorcycle having a handlebar assembly including a clamp. The handlebar includes a first end portion and a second end portion opposite the first end portion and configured to support a hand grip. The first end portion defines an axis and includes an axial locking feature inhibiting movement of the handlebar relative to the clamp in a direction along the axis.

Other aspects of the invention will become apparent by consideration of the detailed description and accompanying drawings.

### BRIEF DESCRIPTION OF THE DRAWINGS

FIG. 1 is a side view of a motorcycle according to an embodiment of the invention.

FIG. 2 is a front view of the motorcycle of FIG. 1.

FIG. 3 is a perspective view of a handlebar assembly of the motorcycle shown in FIG. 1.

FIG. 4 is a exploded perspective view of a portion of the handlebar assembly of FIG. 3.

FIG. 5 is a different perspective view of the exploded handlebar assembly of FIG. 4.

FIG. 6 is a cross section of the handlebar assembly of FIG. 3 taken along line 6-6, illustrating one construction of an axial locking feature.

FIG. 7 is a cross section taken along line 6-6, illustrating the axial locking feature with the clamp loosened.

FIG. 8 is a cross section similar to FIG. 6, illustrating second construction of the axial locking feature.

FIG. 9 is a cross section similar to FIG. 6, illustrating third construction of the axial locking feature.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

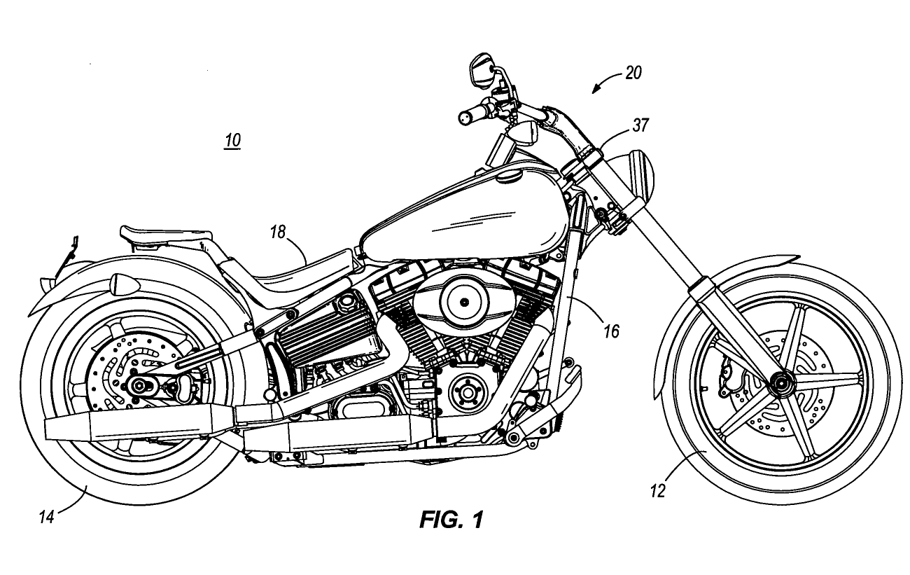

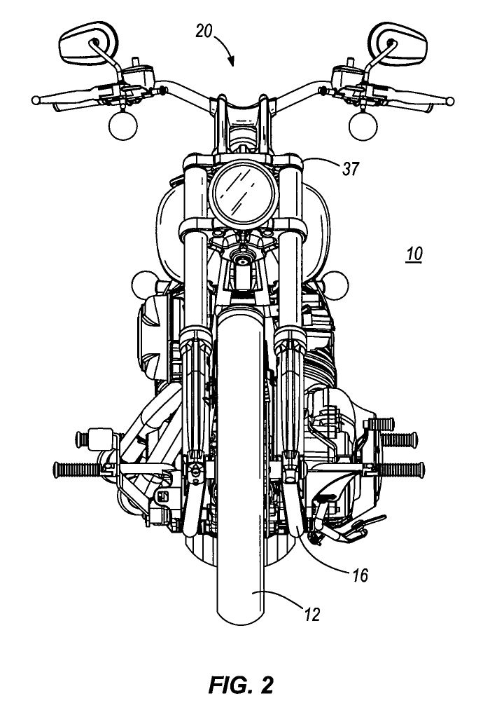

FIGS. 1 and 2 illustrate a motorcycle 10 according to an embodiment of the invention. The motorcycle 10 includes a front wheel 12 and a rear wheel 14 supporting a frame 16 for movement over the ground, a rider seat 18 supported on the frame 16, and a handlebar assembly 20 operably coupled to the front wheel 12 for controlling steering of the motorcycle 10.

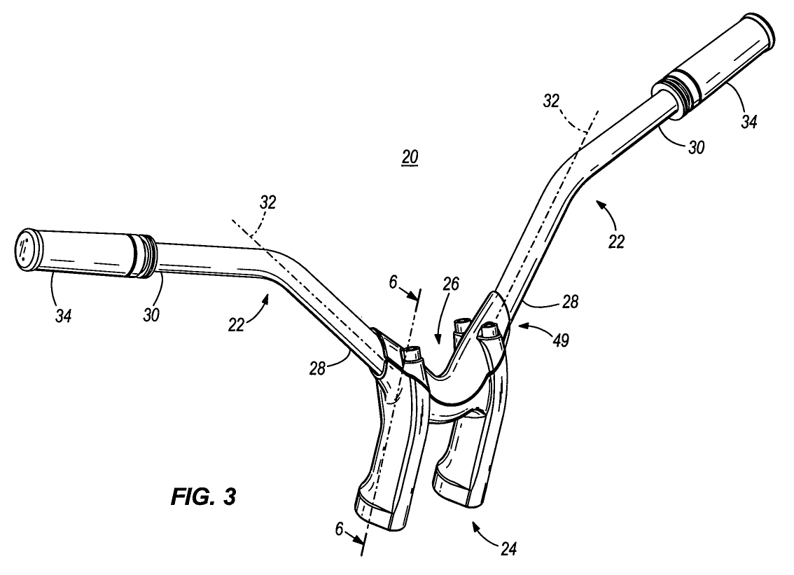

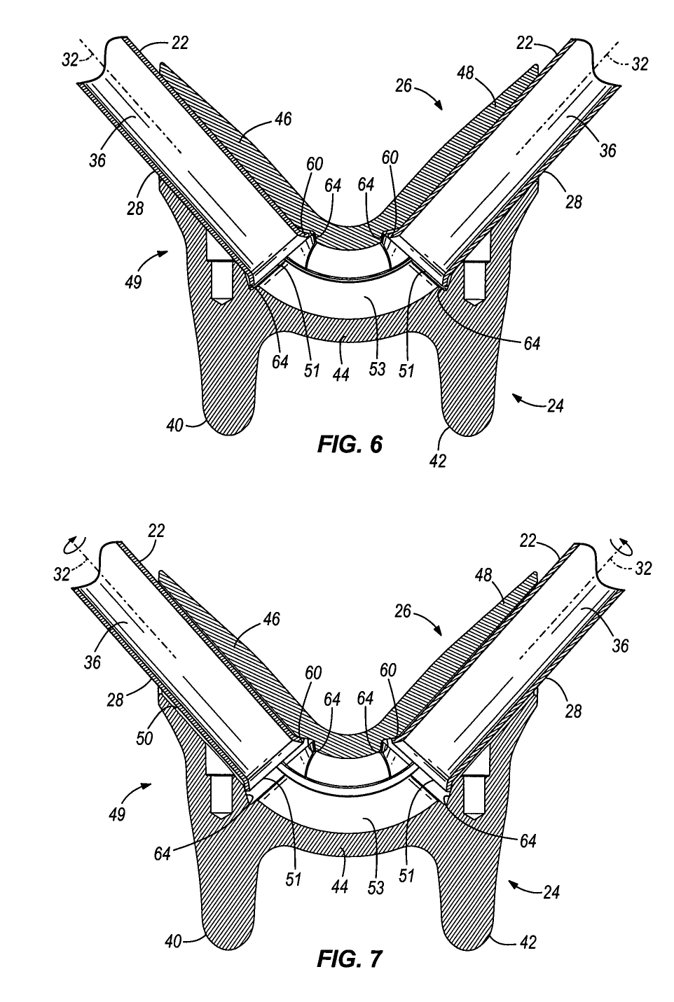

FIGS. 3-7 show the handlebar assembly 20 in greater detail. The handlebar assembly 20 includes a pair of handlebars 22, a riser 24 supporting the handlebars 22, and a cap 26 for securing the handlebars 22 to the riser 24. Each of the handlebars 22 has a first end portion 28 and a second end portion 30. The first end portions 28 are adjacent one another and each define an axis 32 (see FIGS. 6 and 7). The second end portions 30 of the handlebars 22 are spaced apart from each other and are adapted for supporting hand grips 34. The second end portions 30 of the handlebars 22 are capable of being grasped by the rider to steer the motorcycle 10. As illustrated in FIG. 3, the handlebars 22 are angled relative to one another so that the second end portions 30 are within reach of the rider's grasp.

The handlebars 22 are elongated tubular members with an inner bore 36. Objects, including, for example, wires, may be located within the inner bore 36 so as to provide an electrical connection between devices such as operator controls positioned on the second end portions 30 of the handlebars 22.

The riser 24 is coupled to the frame 16 (e.g., an upper triple clamp 37) and is operably coupled to the front wheel 12 for steering the motorcycle 10. In the illustrated embodiment, the riser 24 includes a first riser support 40 and a second riser support 42 that are spaced apart from each other and a generally V-shaped cross-support 44. The first and second riser supports 40, 42 can be integrally formed with one another and with the cross-support 44. In other embodiments, one, two, three or more riser supports are provided. The riser supports 40, 42 can be integrally formed with one another or coupled to one another, and can be integrally formed with one or more cross-supports 44, or coupled to one or more cross-supports 44.

The cap 26 is generally V-shaped and includes a first cap portion 46 and a second cap portion 48 that are integrally formed with one another. In other embodiments, one, two, three or more cap supports are provided. The cap supports 46, 48 can be integrally formed with one another or be coupled to one another.

As shown in FIG. 7, the cap 26 and the riser 24 form a clamp 49 defining a cavity or space 50. The riser 24 and the cap 26 each have a generally concave inner profile facing the cavity 50. In the illustrated embodiment, the riser 24 inner profile generally faces the cap 26 inner profile. The riser 24 and cap 26 inner profile are generally complementary to an outer profile of the handlebar first end portions 28. In the illustrated embodiment, the handlebars 22 are generally tubular and have a curved, circular outer profile. Therefore, the riser 24 and the cap 26 inner profile are curved and generally circular as well. An inner radius of the cap 26 profile and of the riser 24 profile is approximately the same as an outer radius of the handlebars 22. This provides a secure grip between the cap 26 and the handlebars 22 when the handlebars 22 are clamped between the riser 24 and the cap 26.

As illustrated in FIG. 6, inner ends 51 of the handlebars 22 are slightly spaced apart from one another. A gap 53 is created between the inner ends 51 that is protected by the riser 24 and the cap 26. Wires (not shown) can extend through the inner ends 51 of the handlebars 22 into the gap 53, and through a wiring passageway (not shown) in the riser 24 for routing to remote locations on the motorcycle 10. The wires are shielded from view from the front of the motorcycle 10.

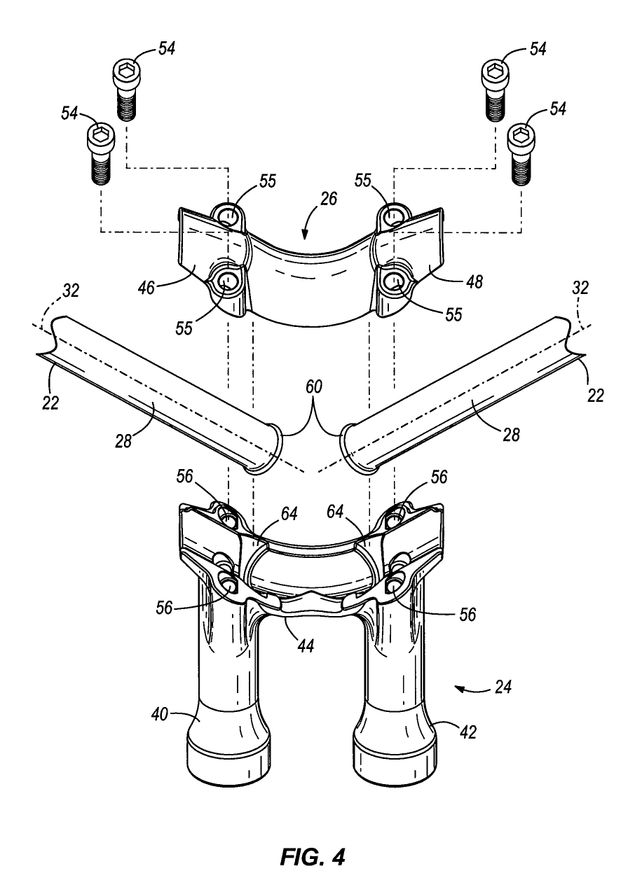

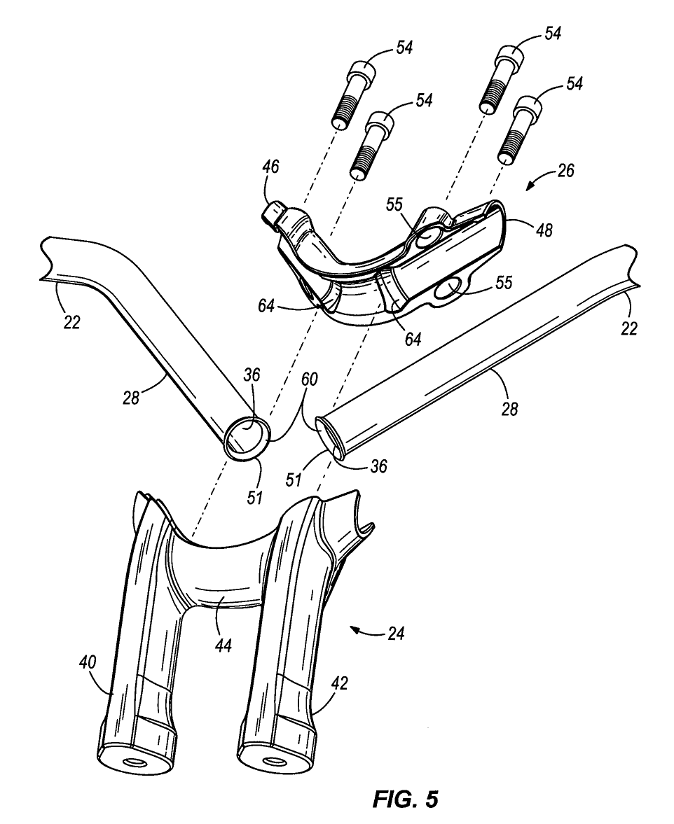

Fasteners 54 are provided for securing the cap 26 to the riser 24. As illustrated in FIG. 4, the cap 26 has two pairs of bores 55 for receiving the fasteners 54, which may be screws, bolts or the like. Likewise, the riser 24 has two pairs of bores 56 for receiving the fasteners 54. The fasteners 54 are of a length such that when the handlebars 22 are located between the riser 24 and the cap 26, the fasteners 54 extend from the cap 26 to the riser 24. The riser bores 56 (see FIG. 4) and the cap bores 55 (see FIG. 5) are positioned forward of and rearward of the cavity 50 between the riser 24 and the cap 26 (see FIG. 7). The fasteners 54 therefore avoid engagement with the handlebars 22 themselves when the handlebars 22 are clamped in the cavity 50 between the riser 24 and the cap 26. Thus, the handlebars 22 are held in position by a clamping force between the riser 24 and the cap 26 upon tightening of the fasteners 54.

The handlebar assembly 20 further includes an axial locking feature for inhibiting movement of the handlebars 22 relative to the clamp 49 in a direction along the axis 32 defined by the first end portion 28. In one embodiment, the axial locking feature is a flare 60 at the first end 51 of the handlebars 22. The clamp 49 includes a recess 64 that cooperates with the flare 60 to inhibit movement of the handlebars 22 relative to the clamp 49 along the axis 32 of the first end portion 28. The flare 60 is received in the recess 64 and clamped between the riser 24 and the cap 26, thereby being inhibited from moving along the axis 32.

In the embodiment illustrated in FIGS. 4 and 5, the recess 64 is formed in the cap 26 inner profile and the riser 24 inner profile for each of the handlebar first end portions 28. The recess 64 is annular, forming a portion of a ring on the inner profiles of the riser 24 and the cap 26. In the embodiment illustrated in FIGS. 3-7, the recess 64 extends fully across the inner surfaces of the riser 24 and the cap 26, thereby permitting each of the handlebars 22 to be rotated 360 degrees. In other embodiments, however, the rotational movement of the handlebars 22 is limited. For example, the flare 60 of the handlebars 22 may extend only partially about the circumference of the handlebars 22. Likewise, the recess 64 may extend only partially about the inner circumference of the riser 24 and cap 26. The length of the recess 64 relative to the length of the flare 60 may be sized so that rotation of the handlebars 22 is limited by the degree of travel permitted by the flare 60 within the recess 64.

The recess 64 provides a convenient location for assembling the handlebars 22 with the riser 24 and cap 26 so that the inner ends 51 of the handlebars 22 are spaced apart from one another and positioned relative to the riser 24 and to the cap 26 reliably and consistently. In addition, inner surfaces of the riser 24 and the cap 26 engage the flare 60 of the handlebars 22 when the cap 26 is secured to the riser 24. This prevents axial movement of the handlebars 22 relative to the riser 24 and to the cap 26. In other words, the handlebars 22 are prevented from sliding towards or away from one another. The flare 60 permits the handlebars 22 to be individually rotated relative to the riser 24 and the cap 26 upon slightly loosening the fasteners 54. The position of the second end portions 30 of the handlebars 22 is therefore adjustable upon rotation of the handlebars 22 relative to the riser 24 and to the cap 26. This allows the rider to position the handlebars 22 in a comfortable and convenient location.

The rotational orientation of the handlebars 22 can be easily adjusted by slightly loosening the cap 26 from the riser 24 without changing the axial position of the handlebars 22. Likewise, should the cap 26 inadvertently become loosened from the riser 24, as illustrated in FIG. 7, the handlebars 22 may rotate slightly, but are inhibited from disengaging from the riser 24 and the cap 26 by moving relative to the clamp 49 along the axis 32 of the first end portion 28.

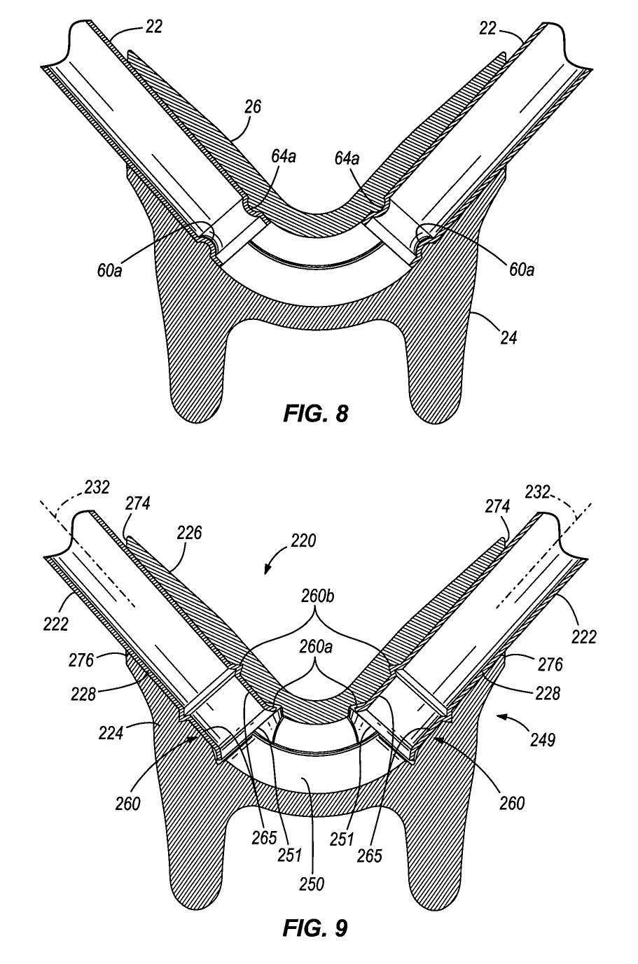

The flare 60 provides a means of inhibiting movement of the handlebars 22 relative to the clamp 49 along the axis 32 of the first end portion 28. The flare 60 permits rotational movement of the handlebars 22. In other constructions, the axial locking feature is disposed on the clamp 49, and the handlebars 22 cooperate with the axial locking feature to inhibit movement of the handlebars 22 relative to the clamp 49 along the axis 32 of the first end portion 28. For example, FIG. 8 illustrates an axial locking feature according to another embodiment of the invention, in which the axial locking feature can be an annual protrusion 60a on the inner profile of the riser 24 and of the cap 26 that cooperates with an annular recess 64a in the outer surface of the handlebars 22. In other embodiments, the axial locking feature is a protrusion such as a pin or rib that is received in a cooperating recess such as a groove or slot.

FIG. 9 illustrates another construction of a handlebar assembly 220 including a riser 224 and a cap 226 forming a clamp 249 and defining a cavity 250, and a pair of handlebars 222 received in the cavity 250 and clamped between the riser 224 and the cap 226. The handlebars 222 include a first end portion 228 received in the cavity 250 and defining a first axis 232, and a second end portion 230. The handlebar assembly 220 further includes an axial locking feature for inhibiting movement of the handlebars 222 relative to the clamp 249 along the first axis 232. The axial locking feature includes a spaced apart pair of protrusions 260a, 260b on the outer surface of the handlebar first end portion 228. One of the protrusions 260a can be a flared end 251 of the handlebar 222. The other or outer of the protrusions 260b can be located within the clamp 249. The riser 224 and the cap 226 are seated in a gap 265 between the protrusions, thereby cooperating with the axial locking feature to inhibit movement of the handlebars 222 relative to the riser 224 and the cap 226 along the first axis 232. In another construction, the outer protrusion 260b is located outside the clamp 249 to engage a side surface 274, 276 of the riser 224 and the cap 226.

Thus, the invention provides, among other things, a handlebar assembly including an axial locking feature for inhibiting movement of handlebars relative to a clamp along an axis of the handlebars. Various features and advantages of the invention are set forth in the following claims.

What is claimed is:

1. A handlebar assembly for a motorcycle, the handlebar assembly comprising:
a riser;
a cap coupled to the riser, the cap and riser defining a clamp having a cavity; and
a handlebar having a first end portion and a second end portion opposite the first end portion and configured to support a hand grip, the first end portion defining an axis, the first end portion at least partially received within the cavity, wherein at least one of the clamp and the first end portion includes an axial locking feature, inhibiting movement of the handlebar relative to the clamp in a direction along the axis.

2. The handlebar assembly of claim 1, wherein the axial locking feature includes a flared end on the first end portion.

3. The handlebar assembly of claim 2, wherein the axial locking feature includes an annular recess in the clamp.

4. The handlebar assembly of claim 1, wherein the handlebar is rotatable relative to the riser.

5. The handlebar assembly of claim 1, further comprising:
a second riser;
a second cap coupled to the second riser, the second riser and cap defining a second clamp having a second cavity; and
a second handlebar having a first end portion and a second end portion opposite the first end portion of the second handlebar and configured to support a second hand grip, the first end portion of the second handlebar defining a second axis, the first end portion of the second handlebar at least partially received within the second cavity, wherein at least one of the second clamp and the first end portion of the second handlebar includes a second axial locking feature, the second axial locking feature inhibiting movement of the second handlebar relative to the second clamp in a direction along the second axis.

6. The handlebar assembly of claim 5, wherein the first end portions of the first and second handlebars are spaced apart from one another.

7. The handlebar assembly of claim 5, wherein the first and second risers are integrally formed as a single riser including a wiring passageway open to the first end portions of the first and second handlebars.

8. The handlebar assembly of claim 7, wherein the single riser is generally V-shaped.

9. The handlebar assembly of claim 5, wherein the first and second caps are integrally formed as a single cap, the single cap being generally V-shaped.

10. A motorcycle comprising:
a frame;
an engine coupled to the frame; and
a handlebar assembly coupled to the frame, the handlebar assembly comprising:
a riser;
a cap coupled to the riser, the cap and riser defining a clamp having a cavity; and
a handlebar having a first end portion and a second end portion opposite the first end portion and configured to support a hand grip, the first end portion defining an axis, the first end portion at least partially received within the cavity, wherein at least one of the clamp and the first end portion includes an axial locking feature, inhibiting movement of the handlebar relative to the clamp in a direction along the axis.

11. The motorcycle of claim 10, wherein the axial locking feature includes a flared end on the first end portion.

12. The motorcycle of claim 10, wherein the axial locking feature includes an annular recess in the clamp.

13. The motorcycle of claim 10, wherein the handlebar is rotatable relative to the riser.

14. The motorcycle of claim 10, further comprising:
a second riser;
a second cap coupled to the second riser, the second riser and cap defining a second clamp having a second cavity; and
a second handlebar having a first end portion and a second end portion opposite the first end portion of the second handlebar and configured to support a second hand grip, the first end portion of the second handlebar defining a second axis, the first end portion of the second handlebar at least partially received within the second cavity, wherein at least one of the second clamp and the first end portion of the second handlebar includes a second axial locking feature, the second axial locking feature inhibiting movement of the second handlebar relative to the second clamp in a direction along the second axis.

15. The motorcycle of claim 14, wherein the first end portions of the first and second handlebars are spaced apart from one another.

16. The motorcycle of claim 14, wherein the first and second risers are integrally formed as a single riser including a wiring passageway open to the first end portions of the first and second handlebars.

17. The motorcycle of claim 16, wherein the single riser is generally V-shaped cross-support.

18. The motorcycle of claim 14, wherein the first and second caps are integrally formed as a single cap, the single cap being generally V-shaped.

19. A handlebar for a motorcycle having a handlebar assembly including a clamp, the handlebar comprising:
a first end portion defining an axis, the first end portion including an axial locking feature for inhibiting movement of the handlebar relative to the clamp in a direction along the axis; and
a second end portion opposite the first end portion and configured to support a hand grip.

20. The handlebar of claim 19, wherein the axial locking feature includes a flared end on the first end portion.
